(19) United States
(12) Patent Application Publication
(10) Pub. No.: US 2005/0023503 A1
(43) Pub. Date: Feb. 3, 2005

(54) Engine coolant composition and methods for use thereof

(75) Inventors: Samuel N. Pearce, Callaway, VA (US); Randall Z. Hodges, Moneta, VA (US); Richard J. Pelot, Pittsburgh, PA (US); David P. Eskra, Sewickley, PA (US)

Correspondence Address: OBLON, SPIVAK, MCCLELLAND, MAIER & NEUSTADT, P.C., 1940 DUKE STREET, ALEXANDRIA, VA, 22314, US

(73) Assignee: LIQUID PERFORMANCE, INC., ROANOKE, VA (US)

(21) Appl. No.: 10/768,005

(22) Filed: Feb. 2, 2004

Related U.S. Application Data
(63) Continuation of application No. 60/443,873, filed on Jan. 31, 2003.

(51) Int. Cl. C09K 5/00

(52) U.S. Cl. 252/71

(57) ABSTRACT

An engine coolant/antifreeze composition is provided containing at least one glycol, preferably propylene glycol, at least one fluorosurfactant and water, and optionally containing one or more defoamers, corrosion inhibitors and/or colorants, as desired, and provides engines using the composition therein with significant lowering of engine running temperatures, and/or significant improvements in horsepower retention and efficiency, particularly when used in motorcycle engines.

### BACKGROUND OF THE INVENTION

1. Field of Invention

The present invention relates to an engine coolant composition and/or antifreeze composition, which provides for cooler engine running, particularly in high temperature operating motorcycle engines.

2. Discussion of the Background

Several attempts have been made to develop an engine coolant with cooling ability and corrosion prevention in the engines of motor vehicles. While some conventional coolants can be adequate for the purpose and function for which they are specifically used, the coolants often contain many additives that are not suited for all engines and motor vehicle applications. Over a period of time, additives such as silicates, azoles, and nitrates can be consumed and add to the corrosive effect on the engine of a motor vehicle. Consequently, many of the coolants that contain additives can have a deleterious effect on the engine over time unless extreme precautionary measures are taken.

Most conventional engine coolants use ethylene glycol as the primary component other than water. Although ethylene-glycol based engine coolants provide adequate cold weather protection and corrosion resistance, these products are hazardous to the environment. For instance, ethylene glycol based products are poisonous to humans, animals and plant life. Also, there exists an added risk of danger from handling coolants that may contain ethylene glycol, which is hazardous to humans.

Various type of engine coolants are available in the automotive industry that can be used to inhibit corrosion in engines and maintain the engines effectiveness. However, many of these products contain additives having chemical and physical characteristics that can nullify the efficiency of the coolant. Engine efficiency has become important for fuel consumption concerns and even more important to owners of high performance automobiles and motorcycles where engine performance is a priority. The various coolants presently available on the market sometimes have too many additives or a coolant that requires the user to guess at preparing suitable concentrations for a particular vehicle. Engine coolants should be simple to use and effective at preventing an engine from overheating or freezing. Accordingly, there exists a need for an engine antifreeze-coolant that is non hazardous, while providing effective, efficient and improved cooling capabilities and corrosion prevention in an engine of a motor vehicle, particularly motorcycle engines.

### SUMMARY OF THE INVENTION

Accordingly, one object of the present invention is to provide an engine coolant composition that provides cooler engine operation, particularly in high temperature operations such as motorcycle engines.

Another object of the present invention is to provide a method for preparation of an engine coolant composition that provides for cooler and/or smoother engine operation.

These and other objects of the present invention have been satisfied by the discovery of an engine coolant composition comprising at least one glycol, at least one fluorosurfactant, and water.

### DETAILED DESCRIPTION OF THE INVENTION

Various objects, features and attendant advantages of the present invention will be more fully appreciated as the same becomes better understood from the following detailed description of the preferred embodiments of the invention, which are not intended to be limiting.

The present invention relates to an engine coolant and/or antifreeze composition, which comprises at least one glycol, at least one fluorosurfactant, and water. The composition can further optionally contain any conventional additives used for engine coolant or antifreeze compositions, including, but not limited to, one or more of defoamers, corrosion inhibiting agents, colorants, and other non-fluorinated surfactants. The present invention further comprises a method of making the present invention engine coolant composition, and methods of using the composition to reduce friction, reduce operating temperature, prevent corrosion, and/or provide better retention of horsepower under normal operating conditions of an engine in which the composition is used. Further the present invention composition is useful for increasing the boiling point of a cooling liquid and/or decreasing the freezing point of a cooling liquid used in an engine system.

For convenience, the terms, composition, coolant and/or antifreeze are used interchangeably herein.

The composition of the present invention comprises water, at least one glycol, and at least one fluorosurfactant.

The water contained in the composition can be any desired amount, preferably from 1 to 99% by weight, which includes all values and subranges therebetween, including 1, 2, 3, 4, 5, 6, 7, 8, 9, 10, 15, 20, 25, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62. 63, 64, 65, 66, 67, 68, 69, 70, 71, 72, 73, 74, 75, 76, 77, 78, 79, 80, 85, 90, 95, 96, 97, 98, 99% by weight, based on the total weight of the composition. More preferably, the amount of water is in the range from 30 to 70% by weight, most preferably from 40 to 60% by weight. The water is preferably distilled and/or deionized. Preferably, the water is deionized before contacting with the other components of the composition.

The at least one glycol used can be in any desired amount, preferably from 1 to 99% by weight, which includes all values and subranges therebetween, including 1, 2, 3, 4, 5, 6, 7, 8, 9, 10, 15, 20, 25, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62. 63, 64, 65, 66, 67, 68, 69, 70, 71, 72, 73, 74, 75, 76, 77, 78, 79, 80, 85, 90, 95, 96, 97, 98, 99% by weight, based on the total weight of the composition. More preferably, the ratio of glycol:water is in the range of from 30:70 to 70:30, still more preferably from 40:60 to 60:40, most preferably about 45:55 to 55:45. One or more glycols may be present. Suitable glycols are preferably water-soluble glycols, including, but not limited to, one or more of ethylene glycol, hexylene glycol, di-ethylene glycol, di-propylene glycol and propylene glycol. Propylene glycol is particularly preferred.

The composition of the present invention further comprises at least one fluorosurfactant in an amount of 0.001 to 50% by weight, which includes all values and subranges therebetween, including 0.002, 0.003, 0.004, 0,005, 0,006, 0.007, 0.008, 0.009, 0.01, 0.02, 0.03, 0.04, 0.05, 0.06, 0.07, 0.08, 0.1, 0.2, 0.3, 0.4, 0.5, 0.6, 0.7, 0.8, 0.9, 1, 2, 3, 4, 5, 6, 7, 8, 9, 10, 11, 12, 13, 14, 15, 16, 17, 18, 19, 20, 21, 22, 23, 24, 25, 30, 31, 32, 33, 34, 35, 36, 37, 38, 39, 40, 41, 42, 43, 44, 45, 46, 47, 48, 49 and 50% by weight, based on the total weight of the composition. The fluorosurfactant desirably causes a reduction in contact angle (e.g., droplet height) compared to an untreated water/glycol mixture, modifies the surface properties of liquids or solids, or reduces surface tension in a fluid or the interfacial tension between two immiscible fluids, for example oil and water. The measurement of contact angle and/or surface tension is known in the art. The terms, fluorosurfactant and fluorinated surfactant are used interchangeably herein. Preferably, the fluorosurfactant is soluble in water. Preferable fluorosurfactants include, but are not limited to, the ZONYL fluorosurfactants (anionic, nonionic and amphoteric fluorinated surfactants) including, but not limited to, ZONYL FSA, FSE, FSJ, FSP, TBS, FSO, FSH, FSN, FSD and FSK, more preferably the non-ionic ZONYL fluorosurfactants, most preferably ZONYL FSH, FSN or FSP (typically mixtures of a fluoroalkyl alcohol substituted polyethylene glycol with water and a glycol or glycol ether such as dipropylene glycol methyl ether) (all commercially available from DuPont). The fluorosurfactant can be used alone, or can be combined with other fluorosurfactants or non-fluorine containing surfactants as desired.

In addition to the main components of the composition, the present invention engine coolant can optionally contain one or more conventional additives, such as defoamers, corrosion inhibitors and/or colorants, such as dyes.

Defoamer, if present, is used in an amount sufficient to reduce buildup of foam or reduce foam or trapped air by causing the bubbles to burst, thus releasing the trapped air. Preferably the defoamer is used in an amount of from 0.01 to 50% by weight, which includes all values and subranges therebetween, including 0.01, 0.02, 0.03, 0.04, 0.05, 0.06, 0.07, 0.08, 0.1, 0.2, 0.3, 0.4, 0.5, 0.6, 0.7, 0.8, 0.9, 1, 2, 3, 4, 5, 6, 7, 8, 9, 10, 11, 12, 13, 14, 15, 16, 17, 18, 19, 20, 21, 22, 23, 24, 25, 30, 31, 32, 33, 34, 35, 36, 37, 38, 39, 40, 41, 42, 43, 44, 45, 46, 47, 48, 49 and 50% by weight, based on the total weight of the composition. One or more than one defoamer may be present. Preferable defoamers include, but are not limited to, PATCOTE 415 or 462 (an ethylene glycol n-butyl ether based defoamer made by American Ingredients Company), PLURONIC L61 (a block copolymer manufactured by BASF Corp.), DOW AF9020 (a silicone emulsion produced by Dow Chemical), ADVANTAGE 831 (a hydrocarbon oil emulsion produced by Hercules, Inc.), POLYTERGENT P32A (an EO/PO copolymer made by Olin Corp.), LANDA 5600 (oil soluble, water miscible defoamer produced by Landa Corp.) and AF-20F (a silicone oil emulsion produced by Performance Chemicals LLC), for example.

Useful corrosion inhibitors, if desired, can be used in an amount sufficient to inhibit or reduce corrosion of exposed metal surfaces in contact with the engine cooling composition of the present invention, preferably in an amount of from 0.01 to 50% by weight, which includes all values and subranges therebetween, including 0.01, 0.02, 0.03, 0.04, 0.05, 0.06, 0.07, 0.08, 0.1, 0.2, 0.3, 0.4, 0.5, 0.6, 0.7, 0.8, 0.9, 1, 2, 3, 4, 5, 6, 7, 8, 9, 10, 11, 12, 13, 14, 15, 16, 17, 18, 19, 20, 21, 22, 23, 24, 25, 30, 31, 32, 33, 34, 35, 36, 37, 38, 39, 40, 41, 42, 43, 44, 45, 46, 47, 48, 49 and 50% by weight, based on the total weight of the composition. Preferable corrosion inhibitors include any conventionally or commercially used corrosion inhibitor, including, but not limited to, sodium nitrate, sodium nitrite, azonitrile(s), dipotassium phosphate, sodium benzoate and mixtures thereof, for example. More preferably the corrosion inhibitor is one of the PENRAY corrosion inhibitors available from The Penray Companies, such as PENRAY 2792 (an aqueous solution of nitrites, nitrates and sodium hydroxide).

The present invention composition can, if desired, contain a colorant in order to help a user readily distinguish the composition from colorless liquids, particularly from water. Suitable colorants can be any conventional colorant, and can be any desired color, including but not limited to orange, blue, green, red and yellow, and any combination thereof. If present, the dye can be used in any amount to provide the color desired, preferably from 0.01 to 50% by weight, which includes all values and subranges therebetween, including 0.01, 0.02, 0.03, 0.04, 0.05, 0.06, 0.07, 0.08, 0.1, 0.2, 0.3, 0.4, 0.5, 0.6, 0.7, 0.8, 0.9, 1, 2, 3, 4, 5, 6, 7, 8, 9, 10, 11, 12, 13, 14, 15, 16, 17, 18, 19, 20, 21, 22, 23, 24, 25, 30, 31, 32, 33, 34, 35, 36, 37, 38, 39, 40, 41, 42, 43, 44, 45, 46, 47, 48, 49 and 50% by weight, based on the total weight of the composition. One or more than one dye may be present. More preferably, any light stable, transparent water soluble organic dye is suitable, including but not limited to, Acid Red dyes, methylene blue, uranine dye, wool yellow dye and rhodamine dye, with dyes such as 15189 EOSINE OJ (an Acid Red 87 based dye commercially available from Chemcentral Dyes and Pigments) being particularly preferred.

The present composition may optionally include one or more other additives. These include, but are not limited to, for example, alkali metal borates as corrosion-inhibitors such as disclosed in U.S. Pat. Nos. 4,149,985, 2,566,923, 3,960,740, 2,373,570, and 2,815,328; alkali metal sebacates as corrosion inhibitors such as disclosed in U.S. Pat. No. 2,726,215, U.K. Patent 1,004,259, U.S. Pat. Nos. 4,382,008, 4,561,990, 4,587,028, and 4,588,513; alkali metal molybdates as corrosion-inhibitors such as disclosed in U.S. Pat. Nos. 2,147,409 and 4,561,990; alkali metal mercaptobenzothiazole such as disclosed in U.S. Pat. Nos. 2,815,328, 4,455,248, 4,414,126, and 4,545,925; alkali metal nitrates as corrosion-inhibitors such as disclosed in U.S. Pat. Nos. 2,815,328, 4,508,684, 4,455,248, and 4,587,028; tolyltriazole such as disclosed in U.S. Pat. Nos. 4,242,214, 2,587,028, 4,382,008, and U.K. Patent 1,004,259; alkali metal silicates such as disclosed in U.S. Pat. Nos. 2,815,328, 4,242,214, 4,382,008, 4,382,870, 4,455,248, and 4,149,985, the relevant portions of each of which are hereby incorporated by reference.

One embodiment of the invention provides a composition that comprises 40-60% by weight of propylene glycol, 40-60% by weight water, 0.001-5% by weight of at least one fluorosurfactant, 0.01-5% by weight of at least one corrosion inhibitor, 0.01-5% by weight of at least one defoamer, and 0.01-5% by weight of a dye.

In a particularly preferred embodiment of the present invention, the engine coolant composition comprises an approximately one-to-one mixture of propylene glycol and distilled water, 0.5 to 2 wt % of at least one fluorinated surfactant, from 0.5-2 wt % of at least one defoamer, and at least one corrosion inhibitor.

In a more preferred embodiment, the composition comprises 46.90% by weight of propylene glycol, 49.86% by weight water, 0.0047% by weight of a fluorosurfactant, 3.12% by weight of a corrosion inhibitor, 0.12% by weight of a dye solution, and 0.01% by weight of a defoamer.

In another more preferred embodiment, the composition comprises 49.74% by weight of propylene glycol, 48.76% by weight water, 0.01% by weight of a fluorosurfactant, 1.29% by weight of corrosion inhibitor, 0.08% by weight of a defoamer, and 0.12% by weight of a dye solution.

The surface tension of the composition can be any value that results from the combination of component, but is preferably maintained in a range from 15 to 30 dynes/cm, which includes all values and subranges therebetween, including 15, 16, 17, 17.5, 18, 18.5, 19, 19.5, 20, 21, 22, 23, 24, 25, 26, 27, 28, 29 and 30 dynes/cm.

The pH of the composition may be adjusted as appropriate. Any compound that is pH active is appropriately used, and may be selected according to what is known in the art. The pH may range from 3 to 11, which includes all values and subranges therebetween, including 3.5, 4, 4.5, 5, 5.5, 6, 6.5, 7, 7.5, 8, 8.5, 9, 9.5, 10, 10.5. Amino-methyl propanol is preferable as pH adjuster. Preferably, the pH is adjusted to avoid using any of the reserve alkalinity of the corrosion inhibitor or corrosion inhibitor composition.

Surprisingly and unexpectedly, the use of the present composition as the coolant in an engine, such as a motorcycle or automotive engine, has been shown to provide much cooler (approximately 20° F. cooler) operating temperatures. Further, under normal conditions, engines lose horsepower as the temperature increases during operation. However, using the present invention composition provides better retention of horsepower under normal operating conditions due at least in part to the lower operating temperatures.

The composition of the present invention reduces engine operating temperatures by as much as 20° F., which includes all values in between, including 1, 2, 3, 4, 5, 6, 7, 8, 9, 10, 11, 12, 13, 14, 15, 16, 17, 18, 19, and 20° F. The composition of the present invention further has been found to provide better retention of horsepower in engines under normal operating conditions. One embodiment of the present invention is desirably non-toxic and harmless to the environment, animals and humans. The present invention allows an engine to remain operable and efficient in extreme weather conditions, while maintaining overall engine temperature and performance.

The present invention composition is useful as an engine coolant, antifreeze and/or antifreeze-coolant. More particularly, the present invention provides a method of preparing an engine antifreeze-coolant that can be utilized in the cooling system of any liquid cooled engine, for example a motor vehicle, automobile, motorcycle, generator, reciprocating engine, tractor, marine engine, outboard engine, inboard engine, aircraft engine, and the like. Preferably, the engine is a motorcycle engine.

The composition is prepared by any known mixing method. Preferably, the components are added to the glycol under agitation, preferably in such a manner such as to minimize foaming. More preferably after each component is added the resulting mixture is allowed to stir for approximately 10-15 minutes or more to ensure thorough mixing. After all components have been added and the product is thoroughly mixed, the composition may be used as is, or preferably is filtered to remove any microparticulates. The filtering can be done using any conventional filtering means, such as a small diameter mesh bag, preferably having 10 micron or smaller pores, more preferably a 5 micron mesh bag, or such as a cartridge filter having similar porosity.

The components of the composition may be packaged in separate containers as individual components or any combination thereof and premixed just prior to use. Alternatively, the components of the composition may be packaged together as a single composition and used without any premixing. In a further embodiment, all components of the present composition except water can be prepackaged together, then premixed with water just prior to use

One embodiment of the present invention provides a composition which meets the requirements of ASTM D5216 (Propylene Glycol Base Engine Coolant), the corrosion prevention requirements of ASTM D 3306, ASTM D 4985, GM 1899, GM 1825 including ASTM D 1384 (Glassware Corrosion), ASTM D 2570 (Simulated Service), ASTM D 2809 (Cavitations Erosion-Aluminum Pumps), and ASTM D 4340 (Hot Surface-Aluminum Corrosion), each alone or in combination with another. Preferably, the composition meets or exceeds ASTM D-1384. The entire contents of each of the above tests are hereby incorporated by reference, the same as set forth at length.

The present application is based on U.S. Provisional Application 60/443,873, filed in the U.S. Patent Office on Jan. 31, 2003, the entire contents of which are hereby incorporated by reference.

Obviously, numerous modifications and variations of the present invention are possible in light of the above teachings. It is therefore to be understood that within the scope of the disclosure as understood by one skilled in this art, the invention may be practiced otherwise than as specifically described herein.

1. A composition, comprising:
one or more glycols,
one or more fluorosurfactants, and water.

2. The composition of claim 1, wherein said one or more glycols are at least one member selected from the group consisting of ethylene glycol, propylene glycol, hexylene glycol, diethylene glycol and dipropylene glycol.

3. The composition of claim 1, wherein said one or more fluorosurfactants are at least one member selected from the group consisting of non-ionic, anionic and amphoteric fluorosurfactants.

4. The composition of claim 1, further comprising at least one defoamer.

5. The composition of claim 1, further comprising at least one corrosion inhibitor.

6. The composition of claim 1, further comprising at least one colorant.

7. The composition of claim 4, further comprising at least one corrosion inhibitor.

8. The composition of claim 4, further comprising at least one colorant.

9. The composition of claim 5, further comprising at least one colorant.

10. The composition of claim 7, further comprising at least one colorant.

11. The composition of claim 1, wherein the composition has a surface tension of from 15 to 30 dynes/cm.

12. The composition of claim 1, wherein the composition has a pH of from 3 to 11.

13. The composition of claim 10, wherein the composition comprises 40-60% by weight of propylene glycol, 40-60 % by weight of water, 0.001-5% by weight of at least one fluorosurfactant, 0.01-5% by weight of at least one corrosion inhibitor, 0.01-5% by weight of at least one defoamer and 0.01-5% by weight of a dye as colorant.

14. The composition of claim 10, wherein said composition comprises an approximately 1:1 ratio by weight of water and propylene glycol, 0.5-2% by weight of at least one fluorosurfactant, 0.5-2% by weight of at least one defoamer, 0.01-5% by weight of at least one corrosion inhibitor and 0.01-5% by weight of a dye as colorant.

15. The composition of claim 13, wherein said composition comprises 46.9% by weight of propylene glycol, 49.86% by weight of water, 0.0047% by weight of a fluorosurfactant, 3.12% by weight of a corrosion inhibitor, 0.12% by weight of a dye as colorant and 0.01% by weight of a defoamer.

16. The composition of claim 13, wherein said composition comprises 49.74% by weight of propylene glycol, 48.76% by weight of water, 0.01% by weight of a fluorosurfactant, 1.29% by weight of corrosion inhibitor, 0.08% by weight of a defoamer and 0.12% by weight of a dye as colorant.

17. A method for cooling an engine, comprising:
contacting an engine cooling system with a composition comprising at least one glycol, at least one fluorosurfactant and water.

18. A method for making an engine coolant composition, comprising:
combining, under agitation, at least one glycol, at least one fluorosurfactant and water.

19. The method of claim 18, wherein said combining step further comprises the combining, under agitation, of one or more members selected from the group consisting of defoamers, corrosion inhibitors and colorants.

20. A prepackaged container of engine coolant composition, comprising:
an engine coolant composition comprising water, at least one glycol and at least one fluorosurfactant, and, optionally, one or more members selected from the group consisting of defoamers, corrosion inhibitors and colorants, wherein said engine coolant composition is contained in a container.
